(19) United States
(12) Patent Application Publication
(10) Pub. No.: US 2025/0020492 A1
(43) Pub. Date: Jan. 16, 2025

(54) APPARATUS FOR THE SPATIALLY RESOLVED MEASUREMENT OF A PHYSICAL VARIABLE

(71) Applicant: Luna Innovations Germany GmbH, Köln (DE)

(72) Inventors: Wieland HILL, Odenthal (DE); Thorben JOSTMEIER, Dülmen (DE); Benjamin MARX, München (DE); Joy TOMIN, Hamburg (DE)

(21) Appl. No.: 18/903,476

(22) Filed: Oct. 1, 2024

Related U.S. Application Data
(63) Continuation of application No. PCT/EP2023/058173, filed on Mar. 29, 2023.

(30) Foreign Application Priority Data
Apr. 7, 2022 (DE) 10 2022 108 430.2

(51) Int. Cl. G01D 5/353; H01S 3/067

(52) U.S. Cl. CPC G01D 5/35316; G01D 5/35358; H01S 3/06754

(57) ABSTRACT

An apparatus for the spatially resolved measurement of a physical quantity comprises a first optical fiber for the spatially resolved measurement and a first laser light source for generating laser pulses. The apparatus is configured such that the laser pulses are coupled into the first optical fiber, the laser pulses in the first optical fiber generate signals which are usable for measuring the physical quantity by backscattering and/or reflection, and the signals generated are coupled out of the first optical fiber. The apparatus further comprises an evaluation device configured to determine the physical quantity to be measured in a spatially resolved manner from the signals coupled out, and a second laser light source for generating pump laser radiation in continuous-wave operation. The pump laser radiation causes amplification of the laser pulses and/or of the signals generated in the first optical fiber.

### CROSS REFERENCE TO RELATED APPLICATIONS

This application is a continuation of International Application No. PCT/EP2023/058173, filed on Mar. 29, 2023, which claims priority under 35 U.S.C. § 119 (a)-(d) to German application No. 10 2022 108 430.2 filed on Apr. 7, 2022, the entire contents of which are hereby incorporated by reference.

### TECHNICAL FIELD

The present disclosure relates to an apparatus for the spatially resolved measurement of a physical quantity.

### BACKGROUND

Apparatuses of the aforementioned type are known and can be used for distributed fiber-optic sensing (DFOS) over long distances. Such long distance DFOS systems are typically based on an optical time-domain reflectometry (OTDR) scheme, where a nanosecond laser pulse or a sequence of laser pulses is coupled into an optical fiber attached to or embedded in the structure or object to be monitored. The state of the structure (temperature, strain, vibrations or acoustic signals) is then monitored in a spatially and temporally resolved manner by analyzing returning light signals generated by Rayleigh, Brillouin or Raman scattering as well as by reflections at multiple reflection centers such as fiber Bragg gratings (FBGs) or other weak reflectors in the fiber core. Raman scattering is mainly used for distributed temperature sensing (DTS). Brillouin scattering provides information about temperature and strain (Distributed Strain Sensing-DSS). Rayleigh scattering and reflections are used to analyze vibrations, acoustic signals (Distributed Acoustic Sensing-DAS), dynamic strain and dynamic temperature. Important applications for long-range DFOS include submarine power cables, overhead power lines, pipelines, railways, borders and fences.

The optical budget or the maximum total attenuation of the optical fiber link at which the DFOS system delivers the specified performance, and thus the distance range of a DFOS system, are limited by the coupled-in laser power, the strength of the scattering or reflection effect used and the sensitivity of the detection system.

Optical amplifiers are often used in fiber optic telecommunications systems to extend the range. Optical amplifiers for telecommunications systems usually require electrical power along the fiber link. However, in many applications of distributed fiber optic sensing apparatuses, such as, for example, high voltage DC submarine cables, pipelines, or long fences, electrical power is not available along the glass fiber link. If electrical power is not available along the fiber link, the power of the laser used for signal transmission can be increased. However, the usable laser power is limited by nonlinear effects, such as, for example, the occurrence of modulation instability when the laser power exceeds certain limits.

### SUMMARY

The problem underlying the present disclosure is the creation of an apparatus of the type mentioned at the outset with which the spatially resolved measurement of the physical quantity over larger distances is possible.

The disclosed device comprises a first optical fiber for the spatially resolved measurement, a first laser light source for generating laser pulses, the apparatus being configured to the effect that the laser pulses are coupled into the first optical fiber, that the laser pulses in the first optical fiber generate signals which are usable for measuring the physical quantity by backscattering and/or reflection, and that the signals generated are coupled out of the first optical fiber, an evaluation device configured to determine the physical quantity to be measured in a spatially resolved manner from the signals coupled out, and a second laser light source for generating pump laser radiation in continuous operation, the apparatus being configured to the effect that the laser radiation causes amplification of the laser pulses and/or of the signals generated in the first optical fiber. By the amplifying the laser pulses and/or the signals generated in the first optical fiber, the physical quantity to be measured can also be determined in a spatially resolved manner over distances of more than 50 km.

The evaluation device can, for example, be designed as described in EP 3 139 133 A1.

It is possible that the second laser light source is a semiconductor laser or a fiber laser.

The apparatus can be configured to the effect that the laser pulses in the first optical fiber generate a signal which is usable to measure the physical quantity by Brillouin scattering and/or by Rayleigh scattering and/or by reflection at multiple reflection centers, such as fiber Bragg gratings or other distributed reflectors.

Furthermore, the physical quantity to be measured can be a temperature and/or a strain and/or a vibration and/or an acoustic signal, for example a dynamically changing temperature and/or a dynamically changing strain.

The apparatus can be configured to amplify the laser pulses and/or the signals generated by a Raman effect. This is known as Raman amplification. For this purpose, it is provided in particular that the first laser light source generates laser pulses having a first wavelength when the apparatus is in operation and that the second laser light source generates a pump laser radiation having a second wavelength when the apparatus is in operation, wherein the first wavelength is greater than the second wavelength, in particular wherein the size of the wavelength difference between the first and the second wavelength corresponds to possible wavelength shifts in the Raman spectrum of the material of the core of the first optical fiber. Raman amplification occurs when pump laser radiation with a shorter wavelength in an optical fiber travels with or against the laser pulses to be amplified or the signal to be amplified and when the frequency difference between the pump laser radiation and the laser pulses to be amplified or the signal to be amplified corresponds to a band in the Raman spectrum of the fiber material. In this case, it is possible to amplify the laser pulses and the returning signals simultaneously using the same pump laser radiation. In addition to increasing the distance over which the spatially resolved determination of the physical quantity can be performed, Raman amplification offers the advantage that no electrical energy or additional optical components are required for the amplification on the fiber link used for the measurement.

It can further be provided that the wavelength difference between the first and the second wavelength is not arranged in the maximum of the Raman spectrum of the material of the core of the first optical fiber. As a result, the Raman amplification is lower, the depletion of the pump laser radiation is reduced and the Raman amplification remains efficient even at greater distances.

It is possible that the Raman amplification occurs not only through a 1st order Raman effect, but alternatively or additionally through a higher order Raman effect. With a 2nd order Raman effect, laser radiation with two different wavelengths is supplied. In particular, this can be a first laser radiation having a wavelength of about 1480 nm and a lower power of, for example, 1 mW, and a second laser radiation with a shorter wavelength that is suitable for amplifying the first laser radiation. Systems with a 3rd order Raman effect are also possible. The advantage of higher order Raman effects is that the maximum power at 1480 nm is only reached at some distance from the second laser light source.

It is possible for the apparatus to comprise a second optical fiber and a couple-in device, the second optical fiber being connected to the first optical fiber via the couple-in device, and the apparatus being configured to the effect that the pump laser radiation generated by the second laser light source is coupled into the second optical fiber and is coupled from the second optical fiber into the first optical fiber via the couple-in device, in particular the couple-in device being designed as a wavelength multiplexer or as a multi-port circulator. In this case it can be provided that the couple-in device is spaced apart from the first laser light source, wherein the length of a first section of the first optical fiber from the first laser light source to the couple-in device is between 1 km and 100 km, in particular between 5 km and 75 km, preferably between 10 km and 50 km. With this design, the amplification of the laser pulses and/or the signals only begins after the pump laser radiation has been coupled in and thus at a large distance from the first laser light source. The couple-in device can in particular be arranged at such a distance from the first laser light source that the laser pulses are already weakened by the propagation through the first section of the first optical fiber to the couple-in device, but at the same time are still sufficiently strong to ensure the spatially resolved determination of the physical quantity to be measured. In particular, the power of the laser pulses coupled into the first optical fiber can be selected to be so low that non-linear effects are avoided.

It can be provided that the first optical fiber has a second section which extends away from the couple-in device for coupling the pump laser radiation from the first section of the first optical fiber. The amplification of the laser pulses and/or the signals generated by the laser pulses through backscattering and/or reflection then begins in this second section.

It is possible for the apparatus to comprise at least one active optical fiber, which is in particular doped with erbium, wherein the apparatus is configured to the effect that the pump laser radiation in the at least one active optical fiber causes an amplification of the laser pulses and/or the signals generated in the first optical fiber. It can be provided that the second laser light source generates a pump laser radiation having a second wavelength when the apparatus is in operation, which can be absorbed by the erbium ions in the material of the core of the optical fiber in such a way that a population inversion with more ions in an energetically higher state than in a lower state can be achieved. This can be achieved, for example, with second wavelengths between 1,430 nm and 1,500 nm. The additional active optical fiber enables the laser pulses and/or signals to be effectively amplified via the erbium-doped fiber amplifier (EDFA) forming the active optical fiber in a range in which the pump laser radiation no longer contributes sufficiently to the effective amplification of the laser pulses and/or the signals via Raman amplification. The pump power remaining after attenuation by the fiber only needs to be high enough to generate a population inversion, which is typically the case with powers of only a few mW, such as, for example, 1 mW to 10 mW. Due to a low duty cycle of the pulsed first laser light source with laser pulses in the nanosecond range and the extreme weakness of the returning signals, the active optical fiber—in contrast to telecommunications systems, for example—is operated entirely in the range of small signal amplification, where the population inversion is practically not impacted by the signal amplification. Although the power of the laser pulses in the active optical fiber can be higher than the power of the pump laser radiation, the population inversion is not affected because a large part of the pump energy is accumulated in the active optical fiber in long-lived excited states in the range of, for example, 10 ms.

It is certainly possible that more than one active optical fiber is provided. The active optical fibers can be spaced apart from each other in this case.

It can be provided that the at least one active optical fiber adjoins the second section of the first optical fiber on the side facing away from the first section of the first optical fiber, in particular wherein a third section of the first optical fiber adjoins the active optical fiber on the side facing away from the second section of the first optical fiber. The laser pulses amplified in the at least one active optical fiber, for example up to the limit given by the non-linear effects, then enter this third section, so that the third section can extend over a comparatively large length.

It can certainly be provided that a first of the active optical fibers is arranged between the second and the third section of the first optical fiber and that a second of the active optical fibers adjoins the third section of the first optical fiber on the side facing away from the second section of the first optical fiber, in particular wherein a fourth section of the first optical fiber adjoins the second active optical fiber on the side facing away from the third section of the first optical fiber.

It is possible for the length of the second section of the first optical fiber from the couple-in device for coupling-in the pump laser radiation to the active optical fiber to be between 10 km and 180 km, in particular between 50 km and 150 km, preferably between 100 m and 130 km. It can be provided in particular that the total length of the first and the second and the third section of the first optical fiber is more than 100 km, in particular more than 150 km, preferably between 150 km and 500 km, for example about 250 km.

It is possible for the second laser light source to comprise a plurality of laser apparatuses, wherein at least two of the laser apparatuses of the second laser light source generate pump laser radiations with different wavelengths and/or polarizations when the apparatus is in operation, in particular wherein the apparatus is configured to the effect that the laser radiations emanating from the individual laser apparatuses are coupled to one another, preferably coupled by wavelength multiplexing and/or polarization coupling, before they are coupled into the second optical fiber. By coupling several laser radiations with different wavelengths, significantly higher pump powers can be achieved than with pump lasers that operate with a single wavelength. It is certainly possible to compose the pump laser radiation from significantly more than four different wavelengths.

It can be provided that the apparatus is configured to the effect that signals moving back in the first optical fiber, in particular by a circulator included in the apparatus, preferably a multi-port circulator, are coupled into the second optical fiber from which they are coupled out and supplied to the evaluation device for the spatially resolved determination of the physical quantity to be measured. In this way, even very weak signals can cover the distance from the couple-in device to the evaluation device in the second optical fiber instead of in the first optical fiber, wherein they can be amplified by the pump laser radiation propagating in the second optical fiber. This allows the possible total length of the measuring path provided by the first optical fiber to be further extended.

It is possible for the apparatus to be configured to partially couple pump laser radiation coupled into the first optical fiber via the couple-in device into the first section of the first optical fiber, in particular wherein the apparatus comprises a multi-port circulator and/or a fiber Bragg grating for this partial coupling-in of the pump laser radiation. This variant contributes to the laser pulses and/or the signals generated being amplified by the pump laser radiation in the first section of the first optical fiber as well.

The first and/or the second optical fiber can be designed as single-mode fibers. In particular, the entire fiber structure of the apparatus can be based on single-mode fibers and passive fiber optic components such as polarization combiners, wavelength multiplexers and bandpass filters. The use of multimode fibers and/or free-space optics is also possible.

### BRIEF DESCRIPTION OF THE DRAWINGS

Further features and advantages of example embodiments of the disclosed apparatus are described below with reference to the drawings. The same reference numerals are used for identical or similar parts and for parts with identical or similar functions.

FIG. 1 shows a schematic view of a first embodiment of an apparatus according to the disclosure.

FIG. 2 shows a schematic view of a second embodiment of an apparatus according to the disclosure.

FIG. 3 shows a schematic view of a third embodiment of an apparatus according to the disclosure.

FIG. 4 shows a schematic view of a fourth embodiment of an apparatus according to the disclosure.

FIG. 5 shows a schematic view of a fifth embodiment of an apparatus according to the disclosure.

FIG. 6 shows a diagram in which the signal power generated by an apparatus according to the disclosure is plotted logarithmically against the distance in km.

### DETAILED DESCRIPTION

It is not necessary for an apparatus according to the disclosure to have all of the features described below. It is also possible for an apparatus according to the disclosure to have only individual features of the exemplary embodiments described below.

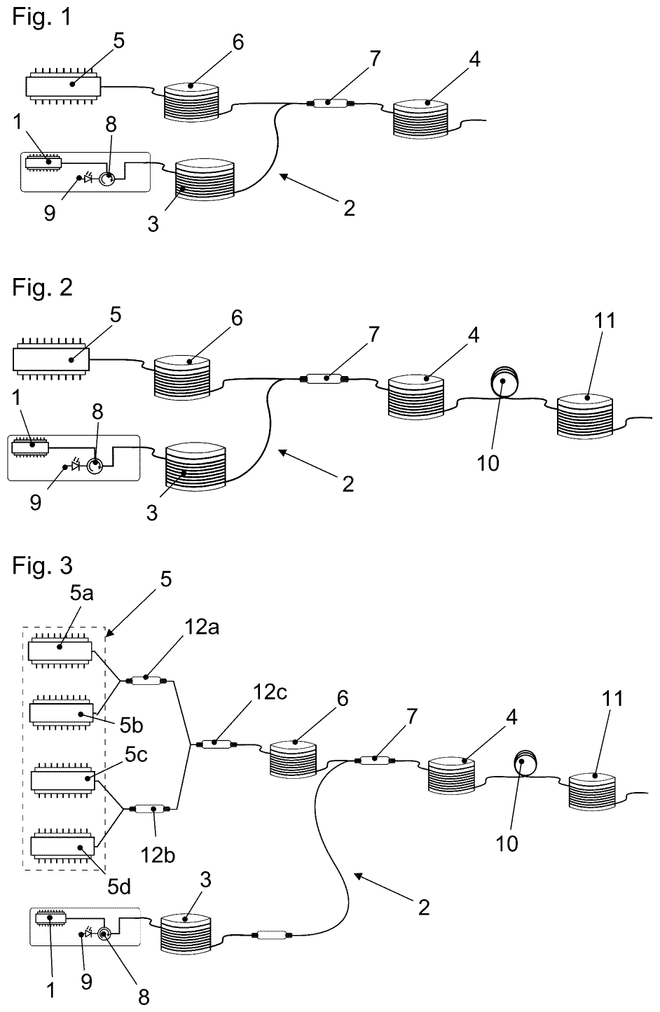

The embodiment of the apparatus depicted in FIG. 1 comprises a first laser light source 1, which can generate laser pulses having a length in the nanosecond range, for example having a length of a few nanoseconds, and a first wavelength of about 1,550 nm. The apparatus also comprises a first optical fiber 2, into which the laser pulses are coupled. First optical fiber 2 has a first section 3, into which the laser pulses are coupled at the end, in particular on the left side in FIG. 1. First optical fiber 2 also has a second section 4, which adjoins first section 3.

First optical fiber 2 comprises a fiber core and a cladding. The fiber core can substantially consist of quartz glass with optional doping.

The apparatus is configured to the effect that the laser pulses in first optical fiber 2 generate a signal which is usable to measure the physical quantity by Brillouin scattering and/or by Rayleigh scattering and/or by reflection at multiple reflection centers, such as fiber Bragg gratings or other distributed reflectors. In this case, the physical quantity to be measured can be a temperature and/or a strain and/or a vibration and/or an acoustic signal, for example a dynamically changing temperature and/or a dynamically changing strain.

The apparatus further comprises a second laser light source 5, which can generate a pump laser radiation in continuous-wave operation having a second wavelength between about 1,430 nm and about 1,500 nm. The apparatus further comprises a second optical fiber 6, into which the pump laser radiation is coupled. The pump laser radiation serves to amplify the laser pulses and/or the signals generated in first optical fiber 2, as will be described in more detail below.

The apparatus further comprises a couple-in device 7, which is designed in particular as a wavelength multiplexer. Second optical fiber 6 is connected to first optical fiber 2 in the connection area of first and second sections 3, 4 via couple-in device 7.

The length of a first section 3 of first optical fiber 2 from first laser light source 1 to couple-in device 7 can be between 1 km and 100 km, in particular between 5 km and 75 km, preferably between 10 km and 50 km. In the connection area of first and second sections 3, 4 of first optical fiber 2, pump laser radiation generated by the second laser light source 5 is coupled into first optical fiber 2. Due to this design, the amplification of the laser pulses and/or the signals only begins in second section 4 of first optical fiber 2 and thus at a large distance from first laser light source 1.

The pump laser radiation can amplify the laser pulses and/or the signals generated through a Raman effect. This is known as Raman amplification. The wavelength difference of about 50 nm to 120 nm between the first wavelength (about 1,550 nm) and the second wavelength (between about 1,430 nm and about 1,500 nm) corresponds to possible wavelength shifts in the Raman spectrum of the material of the core of first optical fiber 2, in particular the quartz glass which can make up the core. It is possible to amplify the laser pulses and the returning signals simultaneously using the same pump laser radiation.

In particular, the chosen wavelength difference is not found in the maximum of the Raman spectrum of the material of the core of first optical fiber 2. As a result, the Raman amplification is lower, the depletion of the pump laser radiation is reduced and the Raman amplification remains efficient even at greater distances. Due to the Raman amplification, the length of second section 4 of first optical fiber 2 can be up to 200 km, preferably between 50 km and 100 km.

The signals generated in first optical fiber 2 move in first optical fiber 2 back to the left in FIG. 1 and are coupled out via a couple-out device 8, designed for example as a circulator, and supplied to an evaluation device 9, which in particular comprises a photodetector. An evaluation device that is configured to determine the physical quantity to be measured in a spatially resolved manner from the coupled-out signals is well known and will not be explained further below. The evaluation device can, for example, be configured as described in EP 3 139 133 A1.

The second embodiment of the apparatus depicted in FIG. 2 corresponds to the first embodiment of the apparatus depicted in FIG. 1 up to the end of second section 4 of first optical fiber 2. In contrast to the first embodiment, the second embodiment additionally comprises an active optical fiber 10 and a third section 11 of first optical fiber 2. Active optical fiber 10 adjoins second section 4 on the side of second section 4 facing away from first section 3. Third section 11 adjoins active optical fiber 10 on the side facing away from second section 4.

Active optical fiber 10 is doped with erbium, so that the pump laser radiation in active optical fiber 10 causes an amplification of the laser pulses and/or the signals generated in first optical fiber 2. The pump laser radiation with a wavelength in the range between about 1,430 nm and about 1,500 nm can be absorbed by the erbium ions in the material of the core of active optical fiber 10 in such a way that a population inversion with more ions in an energetically higher state than in a lower state is achieved.

Additional active optical fiber 10 can enable the laser pulses and/or signals to be effectively amplified via the erbium-doped fiber amplifier (EDFA) forming active optical fiber 10 at the end of second section 4 of first optical fiber 2, in which the pump laser radiation barely contributes to the effective amplification of the laser pulses and/or the signals via Raman amplification. The pump power remaining after attenuation by first two sections 3, 4 of first optical fiber 2 only needs to be high enough to generate a population inversion, which is typically the case with powers of only a few mW, such as, for example, 1 mW to 10 mW.

The length of second section 4 of first optical fiber 3 can be between 10 km and 180 km, in particular between 50 km and 150 km, preferably between 100 km and 130 km. Furthermore, the total length of first and second and third sections 3, 4, 11 of first optical fiber 2 can be more than 100 km, in particular more than 150 km, preferably between 150 km and 500 km, for example about 250 km. The third embodiment of the apparatus depicted in FIG. 3 corresponds to the second embodiment of the apparatus depicted in FIG. 2 except for the design of second laser light source 5. In contrast to the second embodiment, in the third embodiment second laser light source 5 comprises four laser apparatuses 5a, 5b, 5c, 5d. Each of the laser apparatuses 5a, 5b, 5c, 5d generates a pump laser radiation whose wavelength and/or polarization differs from the wavelengths and/or polarization of the pump laser radiation generated by the other laser apparatuses 5a, 5b, 5c, 5d. The wavelengths are found in a wavelength range between about 1,430 nm and about 1,500 nm. In particular, pumping occurs with two different wavelengths, each with two different, preferably orthogonal, linear polarizations. It is certainly possible to compose the pump laser radiation from significantly more than four different wavelengths.

It can also be provided that the pump laser radiation of at least a first of the laser apparatuses is coupled into the first optical fiber at a greater distance from the first laser light source than the pump laser radiation of at least a second of the laser apparatuses. In this case, the pump laser radiation of the at least one first laser apparatus and the at least one second laser apparatus is coupled into different second optical fibers and conducted to the couple-in devices. This makes it possible to avoid non-linear effects in the second optical fiber or the second optical fibers.

The apparatus comprises two polarization couplers 12a, 12b and an additional wavelength multiplexer 12c, by which the laser radiations emanating from the individual laser apparatuses 5a, 5b, 5c, 5d are coupled to one another before they are coupled into second optical fiber 6. By coupling several laser radiations with different wavelengths, significantly higher pump powers can be achieved than with pump lasers that operate with a single wavelength.

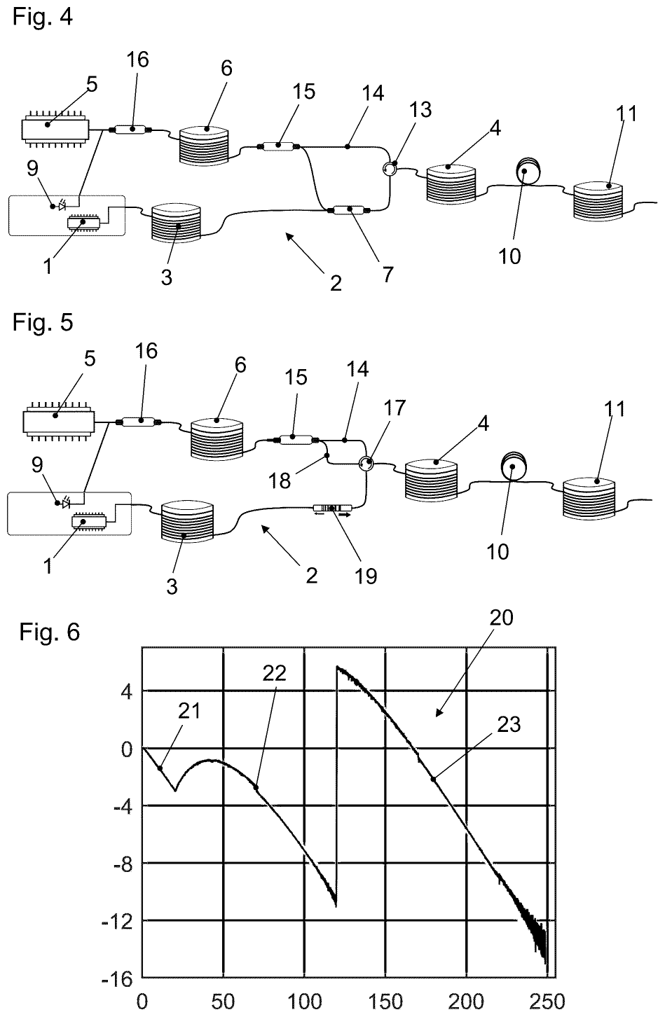

The fourth embodiment of the apparatus depicted in FIG. 4 corresponds to the second embodiment of the apparatus depicted in FIG. 2 except for the connection between first and second section 3, 4 of first optical fiber 2 and the decoupling and supply of the signals generated to couple-out device 9.

In contrast to the second embodiment, in the fourth embodiment second section 4 of first optical fiber 2 is connected to both first section 3 and second optical fiber 6 via a 3-port circulator 13. A short fiber section 14 and a further wavelength multiplexer 15 are provided between 3-port circulator 13 and second optical fiber 6.

Due to the selected design, signals returning in second section 4 of first optical fiber 2 are coupled into second optical fiber 6 via short fiber section 14 and wavelength multiplexer 15. In second optical fiber 10, the signals run to the left in FIG. 4 and are coupled out of second optical fiber 6 at the end facing second laser light source 5 and supplied to evaluation unit 9 via a further wavelength multiplexer 16.

The fifth embodiment of the apparatus depicted in FIG. 5 corresponds substantially to the fourth embodiment of the apparatus depicted in FIG. 4 except for the connection between first and second section 3, 4 of first optical fiber 2 and except for an additional fiber Bragg grating.

In contrast to the fourth embodiment, in the fifth embodiment, a 4-port circulator 17 is provided instead of 3-port circulator 13. 4-port circulator 17 replaces couple-in device 7 provided in the first four embodiments, as described in more detail below.

Second section 4 of first optical fiber 2 is connected to both first section 3 and second optical fiber 5 via the 4-port circulator 17. However, there is an additional connection between second optical fiber 6 and 4-port circulator 17, which is established by a further fiber section 18.

The pump laser radiation passes through this further fiber section 18 to 4-port circulator 17 which is used to it into first section 3 of first optical fiber 2. In this first section 3, the pump laser radiation moves backwards or to the left in FIG. 5 to a fiber Bragg grating 19, which is arranged in an area of first section 3 of first optical fiber 2 adjacent to 4-port circulator 17.

Fiber Bragg grating 19 is designed such that the larger portion of the pump laser radiation, in particular about 80% of the pump laser radiation, is reflected back to the right in the direction of 4-port circulator 17, whereas a smaller portion of the pump laser radiation, in particular about 20% of the pump laser radiation, passes through the fiber Bragg grating 19 to the left in the direction of first laser light source 1.

The portion of the pump laser radiation reflected back to the right in the direction of 4-port circulator 17 is coupled into second section 4 of first optical fiber 2 by 4-port circulator 17. The signals generated in second and third sections 4, 11 of first optical fiber 2 are coupled into second optical fiber 6 via short fiber section 14 and wavelength multiplexer 15 by 4-port circulator 17.

In the fifth embodiment also, the signals in second optical fiber 5 run to the left in FIG. 5 and are coupled out of second optical fiber 6 at the end facing second laser light source 5 and supplied to evaluation unit 9 via a further wavelength multiplexer 16.

FIG. 6 shows a diagram in which the signal power generated by an apparatus according to the disclosure is plotted logarithmically against the distance in km. It can be seen from the diagram that power 20 of the signal generated by Brillouin scattering decreases exponentially in a first area 21, which corresponds to a linear decrease in the diagram in the logarithmic representation of FIG. 6. The signals of first area 21 are generated in first section 3 of first optical fiber 2.

At a distance of about 20 km from first laser light source 1, the power of the signals in a second area 22 increases due to Raman amplification until it drops exponentially again at the end of the second area. The signals of second area 22 are generated in second section 4 of first optical fiber 2.

Active optical fiber 10 is arranged at a distance of 120 km from the first optical fiber. At 120 km there is a correspondingly strong increase, which changes back into an exponential decrease in a third area 23 of the signal. The signals of third area 23 are generated in third section 11 of first optical fiber 2.

Overall, it can be seen that an apparatus according to the disclosure can still generate signals even at distances of more than 200 km, which can be used for the spatially resolved determination of the physical quantity to be measured.

What is claimed is:

1. An apparatus for spatially resolved measurement of a physical quantity, comprising:
a first optical fiber for the spatially resolved measurement;
a first laser light source for generating laser pulses, wherein the laser pulses are coupled into the first optical fiber and generate signals for measuring the physical quantity by backscattering and/or reflection, wherein the signals generated are coupled out of the first optical fiber;
an evaluation device configured to determine the physical quantity to be measured in a spatially resolved manner from the signals coupled out; and
a second laser light source for generating pump laser radiation in continuous operation, wherein the pump laser radiation causes amplification of the laser pulses and/or of the signals generated in the first optical fiber.

2. The apparatus of claim 1, wherein the laser pulses in the first optical fiber generate a signal usable to measure the physical quantity by at least one of: Brillouin scattering, Rayleigh scattering, and reflection at multiple reflection centers, including fiber Bragg gratings or other distributed reflectors.

3. The apparatus of claim 1, wherein the physical quantity to be measured is at least one of: a temperature, a dynamically changing temperature, a strain, a dynamically changing strain, a vibration, and an acoustic signal.

4. The apparatus of claim 1, wherein the apparatus is configured to amplify, by a Raman effect, the laser pulses or the signals generated.

5. The apparatus of claim 4, wherein the first laser light source generates laser pulses having a first wavelength and the second laser light source generates a pump laser radiation having a second wavelength, the first wavelength being greater than the second wavelength, and wherein a wavelength difference between the first and second wavelengths corresponds to possible wavelength shifts in a Raman spectrum of a material of a core of the first optical fiber.

6. The apparatus of claim 5, wherein the wavelength difference between the first and second wavelengths is not found in a maximum of the Raman spectrum of the material of the core of the first optical fiber, and wherein a distance between the maximum of the Raman spectrum and the wavelength difference between the first and second wavelengths is between 10 nm and 40 nm.

7. The apparatus of claim 1, further comprising:
a second optical fiber; and
a couple-in device connecting the second optical fiber to the first optical fiber, the couple-in device comprising a wavelength multiplexer or a multi-port circulator,
wherein the pump laser radiation generated by the second laser light source is coupled into the second optical fiber and is coupled from the second optical fiber into the first optical fiber by the couple-in device.

8. The apparatus of claim 7, wherein the couple-in device is spaced apart from the first laser light source, wherein a length of a first section of the first optical fiber from the first laser light source to the couple-in device is between 1 km and 100 km.

9. The apparatus of claim 8, wherein the length of the first section of the first optical fiber is between 5 km and 75 km.

10. The apparatus of claim 8, wherein the length of the first section of the first optical fiber is between 10 km and 50 km.

11. The apparatus of claim 8, wherein the first optical fiber has a second section that extends away from the couple-in device for coupling-in the pump laser radiation from the first section of the first optical fiber.

12. The apparatus of claim 11, further comprising:
an active optical fiber doped with erbium, wherein the pump laser radiation in the active optical fiber causes an amplification of the laser pulses and/or the signals generated in the first optical fiber.

13. The apparatus of claim 12, wherein the apparatus is configured to achieve a population inversion in the active optical fiber due to a duty cycle of less than 0.1% of the first laser light source, wherein the laser pulses have a length in the range of 10 to 1,000 ns and returning signals have a power between 1 pW and 1,000 pW, wherein the pump laser radiation has a power in the range of 1 mW to 100 mW.

14. The apparatus of claim 12, wherein the active optical fiber adjoins the second section of the first optical fiber on a side facing away from the first section of the first optical fiber, wherein a third section of the first optical fiber adjoins the active optical fiber on a side facing away from the second section of the first optical fiber.

15. The apparatus of claim 14, wherein a length of the second section of the first optical fiber from the couple-in device for coupling-in the pump laser radiation to the active optical fiber is between 10 km and 180 km.

16. The apparatus of claim 15, wherein the length of the second section of the first optical fiber is between 50 km and 150 km.

17. The apparatus of claim 15, wherein a total length of the first, second, and third sections of the first optical fiber is greater than 100 km.

18. The apparatus of claim 8, further comprising a multi-port circulator or a fiber Bragg grating to partially couple pump laser radiation coupled into the first optical fiber via the couple-in device into the first section of the first optical fiber.

19. The apparatus of claim 7, wherein the second laser light source comprises a plurality of laser apparatuses, at least two of the laser apparatuses generating pump laser radiations with different wavelengths and/or polarizations, and wherein the pump laser radiations emanating from individual ones of the laser apparatuses are coupled to one another via wavelength multiplexing and/or polarization coupling before being coupled into the second optical fiber.

20. The apparatus of claim 7, further comprising a multi-port circulator, wherein signals moving back in the first optical fiber via the multi-port circulator are coupled into the second optical fiber from which they are coupled out and supplied to the evaluation device for the spatially resolved measurement of the physical quantity to be measured.
